(19) United States
(12) Patent Application Publication
(10) Pub. No.: US 2009/0061304 A1
(43) Pub. Date: Mar. 5, 2009

(54) NONAQUEOUS ELECTROLYTE SECONDARY BATTERY

(76) Inventors: Yoshiyuki MURAOKA, Osaka (JP); Yukihiro OKADA, Osaka (JP); Tomomichi UEDA, Osaka (JP); Kyosuke MIYATA, Osaka (JP)

Correspondence Address: MCDERMOTT WILL & EMERY LLP, 600 13TH STREET, NW, WASHINGTON, DC, 20005-3096, US

(21) Appl. No.: 12/200,015

(22) Filed: Aug. 28, 2008

(30) Foreign Application Priority Data
Aug. 31, 2007 (JP) 2007-225655

(51) Int. Cl. H01M 2/00

(52) U.S. Cl. 429/163

(57) ABSTRACT

A center pin is inserted in a hollow cavity of an electrode group of a lithium ion secondary battery. The center pin includes a center portion, a perimeter portion and an end portion. The center portion extends in the radial direction of the hollow cavity. The perimeter portion extends along an inner wall surface of the hollow cavity from an end of the center portion in the radial direction of the hollow cavity. The end portion extends from an end of the perimeter portion in the circumferential direction toward the inside of the hollow cavity to be away from the inner wall surface of the hollow cavity but separated from the center portion.

### BACKGROUND OF THE INVENTION

1. Field of the Invention

The present invention relates to nonaqueous electrolyte secondary batteries. In particular, it relates to a nonaqueous electrolyte secondary battery including a center pin.

2. Description of Related Art

For their high energy density at high voltages, nonaqueous electrolyte secondary batteries (mainly lithium ion secondary batteries) have been used as main power sources of mobile devices, such as mobile communication devices and portable electronic devices. Recently, from an environmental viewpoint, there has been a demand for use of DC power sources as power sources for automobiles, backup power sources and power sources for driving large-size devices. As such power sources, use of nonaqueous electrolyte secondary batteries as typified by lithium ion secondary batteries has been required as they can be downsized and reduced in weight while keeping large capacity and high power.

In general, a lithium ion secondary battery contains an electrode group formed of a set of a positive electrode and a negative electrode with a separator interposed therebetween. A stacked structure and a wound structure have been employed for the electrode group structure. The stacked structure includes positive and negative electrodes stacked with a separator interposed therebetween. On the other hand, the wound structure includes positive and negative electrodes wound with a separator interposed therebetween.

For preparation of the wound electrode group, a set of positive and negative electrodes with a separator interposed therebetween is wound around a winding shaft and the shaft is removed after the winding is finished. As a result, a hole in which the winding shaft has been present remains in the wound electrode group, i.e., a hollow cavity extending in the axial direction of the electrode group remains. In some of the lithium ion secondary batteries including the wound electrode group, a cylindrical center pin is inserted in the hollow cavity of the electrode group for the following two reasons.

One of the reasons is to suppress the deformation of electrode plates due to repetitive charges and discharges. More specifically, when a lithium ion secondary battery is repeatedly charged and discharged, the electrode group is likely to expand. However, the electrode group is not able to expand outwardly as it is contained in the outer case. Instead, if the center pin is not present in the hollow cavity of the electrode group, the electrode group is able to expand inwardly. That is, if the center pin is not provided in the hollow cavity of the electrode group, the electrode group expands to reduce the hollow cavity. As the electrode group expands in this way, part of the electrode plates near the hollow cavity is deformed and a short circuit may possibly occur in the deformed part. With the center pin inserted in the hollow cavity of the electrode group, the inward expansion of the electrode group is suppressed and the deformation of part of the electrode plates near the hollow cavity is suppressed. As a result, the short circuit is less likely to occur.

Another reason for the provision of the center pin is to ensure a gas emission passage. More specifically, when the lithium ion secondary battery falls into an abnormal state, an electrolyte contained therein is decomposed to generate gas. As a result, atmospheric pressure in the battery is raised to bring the lithium ion secondary battery into a more dangerous state. The lithium ion secondary battery is preferably provided with a mechanism for emitting the generated gas out of the battery. Specifically, the generated gas is preferably delivered through the hollow cavity in the electrode group and emitted from a vent hole. In this way, the hollow cavity of the electrode group functions as a gas emission passage. When the temperature in the lithium ion secondary battery is raised as high as 200° C. or more (e.g., when the lithium ion secondary battery is accidentally thrown into a flame), the separator made of polyethylene is molten. If the center pin is not present in the hollow cavity of the electrode group, the molten separator may possibly block the hollow cavity. As a result, the gas emission passage may not properly be provided. On the other hand, if the center pin is provided in the hollow cavity of the electrode group, it prevents the molten separator from blocking the hollow cavity. Therefore, the gas emission passage is ensured.

The center pin provided for these reasons is generally formed by rolling a thin metal plate into a cylindrical shape in view of cost and gas emission efficiency. In the process of forming the center pin, the ends of the center pin in the circumferential direction thereof are not connected. Therefore, the center pin is provided with a slit extending in the axial direction of the center pin.

When the lithium ion secondary battery including the thus-configured center pin is dropped from a high altitude or something is dropped on the lithium ion secondary battery, the outer case may be deformed. Due to the deformation of the outer case, the center pin may also be deformed. When the center pin is considerably deformed, the deformed center pin may penetrate and break the separator. As a result, an internal short circuit may occur in the lithium ion secondary battery, which may possibly cause abnormal heat generation in the lithium ion secondary battery.

In order to prevent the deformation of the center pin due to the deformation of the outer case, Publication of Japanese Patent Application No. 2006-4792 (hereinafter referred to as Patent Literature 1) has added a twist to the shape of the center pin. To be more specific, the center pin is formed by bending a single plate into the shape of letter S when viewed in cross section. The S-shaped center pin has a center wall extending in the radial direction of the hollow cavity and a pair of peripheral walls extending from the ends of the center wall and being bent in the opposite directions. Each of the peripheral walls is in the shape of a semicircle when viewed in cross section. The ends of the peripheral walls in the circumferential direction are bent inwardly and received by the center wall. According to this publication, the ends of the center pin in the circumferential direction are prevented from penetrating the separator and therefore the occurrence of an internal short circuit is prevented.

Publication of Japanese Patent Application No. 2003-92148 (hereinafter referred to as Patent Literature 2) discloses a center pin formed by rolling a metal material into a cylindrical shape. The ends of the center pin extending in the axial direction thereof are opposed each other with a gap kept therebetween and bent toward the inside of the center pin.

### SUMMARY OF THE INVENTION

Lithium ion secondary batteries are required to have increased capacity and reduced size. The capacity of the lithium ion secondary battery is increased by increasing the amount of an active material, but the increase of the active material amount raises the size of the electrode group. Further, as the size reduction of the lithium ion secondary battery has been required, the outer case cannot be increased in size even if the size of the electrode group is increased. Thus, the increase of capacity of the lithium ion secondary battery leads to increase of the volume occupied by the electrode group in the outer case.

When the volume occupied by the electrode group in the outer case increases, the volume of the hollow cavity in the electrode group decreases. In other words, a space for the center pin is reduced. If the volume of the hollow cavity is large, the center pin may be less likely to come into contact with the electrode group even if it is deformed. However, if the volume of the hollow cavity is small, the center pin may stick into the electrode group even when it is deformed only slightly in the hollow cavity. Therefore, the smaller the volume of the hollow cavity is, the more the risk of sticking of the center pin into the electrode group increases. Thus, for the increase of the capacity of the lithium ion secondary battery, it is preferable to adopt such a structure that prevents the center pin from sticking into the electrode group when it is deformed.

With the center pins disclosed by Patent Literatures 1 and 2, it is difficult to improve the gas emission efficiency. To be more specific, the center pin of Patent Literature 1 is configured such that the ends of the peripheral walls are bent inwardly and received by the center wall. Therefore, space inside the center pin is closed in the axial direction thereof. In this state, when the lithium ion secondary battery falls into an abnormal state and gas is generated in the battery, the gas is introduced into the space in the center pin only through the open bottom of the center pin. Therefore, the gas cannot be quickly and sufficiently emitted out of the battery, thereby increasing the pressure in the lithium ion secondary battery. As a result, the lithium ion secondary battery may fall into a more dangerous state.

According to the center pin disclosed by Patent Literature 2, only a single gas passage to the inside of the center pin is provided on the circumference of the cylindrical center pin. Also in this case, the gas cannot be quickly and sufficiently emitted out of the battery. As a result, the lithium ion secondary battery may fall into a more dangerous state as described above.

In view of the foregoing, the present invention has been achieved. According to the present invention, the center pin is prevented from sticking into the electrode group and gas emission efficiency is improved even when the battery capacity is increased.

A nonaqueous electrolyte secondary battery of the present invention includes an electrode group and a cylindrical center pin. The electrode group is formed by winding a positive electrode and a negative electrode with a porous insulating layer interposed therebetween and a hollow cavity extending in the axial direction of the electrode group. The center pin is arranged in the hollow cavity to extend in the axial direction of the electrode group and has a center portion, a perimeter portion and an end portion. The center portion extends in the radial direction of the hollow cavity. The perimeter portion extends along an inner wall surface of the hollow cavity from an end of the center portion in the radial direction of the hollow cavity. The end portion extends from an end of the perimeter portion in the circumferential direction toward the inside of the hollow cavity to be away from the inner wall surface of the hollow cavity but separated from the center portion.

As the end portion extends to be away from the inner wall surface of the hollow cavity as described above, the end portion is less likely to stick into the electrode group upon the deformation of the center pin as compared with the case where the end portion extends along the inner wall surface of the hollow cavity.

Further, since the end portion is separated from the center portion, gas, if generated in the lithium ion secondary battery, is quickly guided into the inner space of the center pin.

As to the nonaqueous electrolyte secondary battery of the present invention, an edge of the end portion may be chamfered or thicker than the perimeter portion. With this configuration, even when the edge of the end portion comes into contact with the electrode group, break of the electrode group is less likely to occur as compared with the case where the end portion of the center pin remains sharp.

As to the nonaqueous electrolyte secondary battery of the present invention, the center pin may be curved such that the end portion is positioned between the center portion and the perimeter portion. With this configuration, the contact of the end portion with the electrode group is suppressed by the perimeter portion. Therefore, the break of the electrode group is much less likely to occur.

As to the nonaqueous electrolyte secondary battery of the present invention, a notch may be formed at a boundary between the perimeter portion and the end portion of the center pin, the notch being formed from the inside to the outside of the hollow cavity. With the provision of the notch, the center pin is deformed so that the end portion is guided toward the inside of the hollow cavity when the center pin is compressed in the radial direction. Therefore, the end portion is less likely to come into contact with the electrode group.

As to the nonaqueous electrolyte secondary battery of the present invention, the center pin preferably includes a slit extending in the axial direction thereof between the end portion and the center portion. With this configuration, gas, if generated in the battery, is guided into the inner space of the center pin through the slit. This makes it possible to improve the gas emission efficiency.

### BRIEF DESCRIPTION OF THE DRAWINGS

FIG. 1 is a longitudinal sectional view of a lithium ion secondary battery.

FIG. 2 is a perspective view of a center pin.

FIG. 3 is a cross sectional view of a center pin according to Embodiment 1.

FIGS. 4A to 4C are cross sectional views illustrating how the center pin of Embodiment 1 is deformed.

FIGS. 5A to 5C are cross sectional views illustrating another way how the center pin of Embodiment 1 is deformed.

FIG. 6 is a cross sectional view of a center pin according to Embodiment 2.

FIG. 7 is a cross sectional view of a center pin according to Embodiment 3.

FIG. 8 is a cross sectional view of a center pin according to Embodiment 4.

FIG. 9 is a cross sectional view of a center pin according to Embodiment 5.

FIG. 10 is a cross sectional view of a center pin according to Embodiment 6.

FIG. 11 is a cross sectional view of a center pin according to Comparative Embodiment 1.

FIG. 12 is a cross sectional view of a center pin according to Comparative Embodiment 2.

FIG. 13 is a cross sectional view of a center pin according to Comparative Embodiment 3.

### DETAILED DESCRIPTION OF THE INVENTION

Hereinafter, a lithium ion secondary battery is taken as an example of a nonaqueous electrolyte secondary battery of the present invention and detailed explanation thereof is given with reference to the attached drawings. However, the present invention is not limited to the embodiments described below.

### Embodiment 1

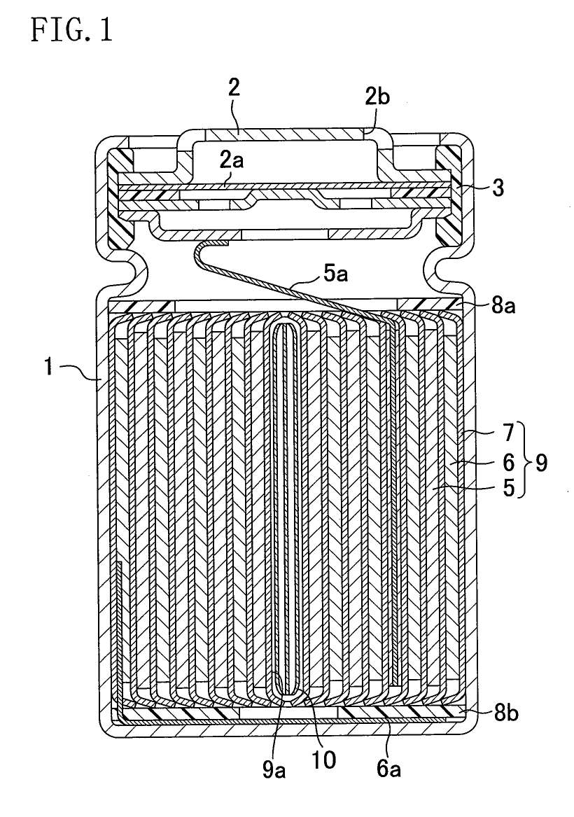

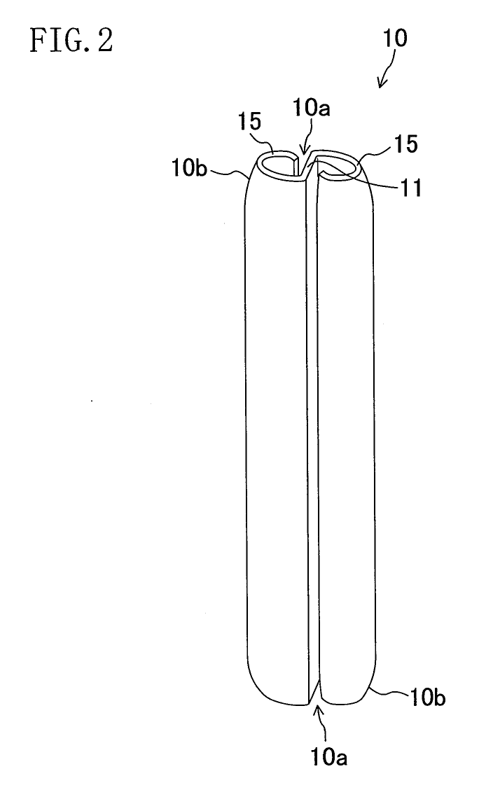

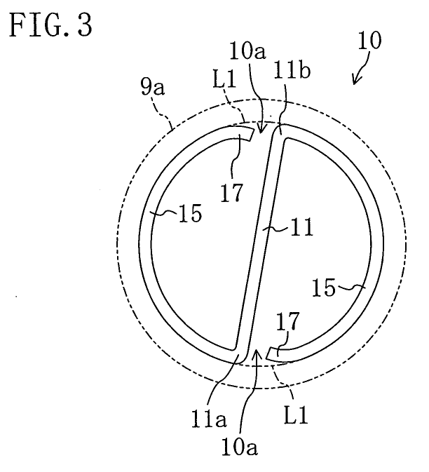

FIG. 1 is a longitudinal sectional view illustrating the structure of a lithium ion secondary battery according to the present embodiment. FIG. 2 is a perspective view of a center pin 10 according to the present embodiment. FIG. 3 is a cross sectional view of the center pin 10.

As shown in FIG. 1, a lithium ion secondary battery of the present embodiment includes an outer case 1 made of, for example, stainless steel, and an electrode group 9 placed in the outer case 1.

The outer case 1 has an opening at the top thereof. A sealing plate 2 is crimped onto the opening with a gasket 3 interposed therebetween. The opening is closed by crimping the sealing plate 2.

The sealing plate 2 is provided with an opening valve 2a and a gas outlet 2b. The opening valve 2a is configured such that it is broken when the pressure in the lithium ion secondary battery exceeds a predetermined value. The opening valve 2a and the gas outlet 2b are provided to emit gas out of the lithium ion secondary battery when the gas is generated in the lithium ion secondary battery and the pressure in the lithium ion secondary battery exceeds a predetermined value due to the gas generation. To be more specific, when the temperature of the lithium ion secondary battery is raised (e.g., when the lithium ion secondary battery is accidentally thrown into a flame), an electrolyte and like materials are decomposed to generate the gas. As a result of the gas generation, the pressure in the lithium ion secondary battery increases. Then, when the pressure in the lithium ion secondary battery exceeds a predetermined value, the opening valve 2a is broken. In this way, the gas generated in the battery passes through space inside the center pin 10 and a gap generated by the break of the opening valve 2a, and then goes out of the lithium ion secondary battery through the gas outlet 2b.

The electrode group 9 has a positive electrode 5, a negative electrode 6 and a porous insulating layer 7. The positive electrode 5 and the negative electrode 6 are wound with the porous insulating layer 7 interposed therebetween. The electrode group 9 is prepared by winding the positive electrode 5, the negative electrode 6 and the porous insulating layer 7 around a winding shaft and then removing the shaft from the obtained electrode group 9. Therefore, in the electrode group 9, a hole in which the winding shaft has been present remains. In other words, a hollow cavity 9a extending in the axial direction is present in the electrode group. The cylindrical center pin 10 is inserted in the hollow cavity 9a.

The center pin 10 is inserted in the hollow cavity 9a of the electrode group 9 for the two reasons described above. One of them is to provide a passage for emitting gas generated when the lithium ion secondary battery falls into an abnormal state and the other is to suppress the deformation of the positive and negative electrodes 5 and 6 due to repetitive charges and discharges.

In many cases, the center pin 10 is formed by cutting a thin plate into a predetermined rectangular shape and winding the thin plate into a cylindrical shape. In view of manufacturability and low manufacturing cost, the ends of the plate extending in the axial direction of the pin are not connected. Therefore, as shown in FIG. 2, the center pin 10 is provided with slits 10a extending in the axial direction thereof. Even if gas is generated in the lithium ion secondary battery, the slits 10a provided in the center pin 10 guide the gas to the gas outlet 2b such that the gas is emitted through the gas outlet 2b. The provision of the slits 10a in the center pin 10 is preferable from a viewpoint of improvement in gas emission efficiency as well as the manufacturability and the low manufacturing cost.

Any material may be used as the thin plate used to form the center pin 10 as long as it is resistant to heat and corrosion by an electrolytic solution and is able to achieve manufacturability and low cost. For example, useable are metal materials such as stainless steel, aluminum, titanium, nickel, copper and iron, organic materials, and a mixture of an organic material and a metal material. The thickness of the thin plate may optimally be set to about 0.05 mm to 0.5 mm in view of manufacturability and low cost.

The center pin 10 further includes tapered portions 10b at both ends in the axial direction thereof. Each of the tapered portions 10b is tapered down to the corresponding end of the center pin 10. With the provision of the tapered portions 10b, the center pin 10 is easily inserted in the hollow cavity 9a of the electrode group 9 and the risk of causing damage to the electrode group 9 is reduced. The tapered portions 10b are preferably formed by drawing or pressing the wound thin plate.

When viewed in cross section, the center pin 10 of the present embodiment includes a center portion 11, a pair of perimeter portions 15 and a pair of end portions 17 as shown in FIG. 3. The center portion 11 is configured to extend in the radial direction of the hollow cavity 9a. Due to the presence of the center portion 11 in the center pin 10 of the present embodiment, the hollow cavity 9a of the electrode group 9 is less likely to be blocked by the center pin 10 even when the center pin 10 is deformed. Therefore, the gas emission efficiency is improved.

The paired perimeter portions 15 are arranged opposite to each other with respect to the center portion 11. One of the perimeter portions 15 extends along an inner wall surface of the hollow cavity 9a from a first end 11a of the center portion 11 in the radial direction of the hollow cavity 9a, while it is separated from a second end 11b of the center portion 11 in the radial direction of the hollow cavity 9a. The other perimeter portion 15 extends along the inner wall surface of the hollow cavity 9a from the second end 11b of the center portion 11, while it is separated from the first end 11a of the center portion 11.

Each of the pair of end portions 17 extends from the corresponding end of the perimeter portion 15 and is bent toward the inside of the hollow cavity 9a so as to be away from the inner wall surface of the hollow cavity 9a. To be more specific, each of the end portions 17 is located more inside in the hollow cavity 9a than a virtual circumferential surface L1 shown in FIG. 3. The virtual circumferential surface L1 in FIG. 3 is a surface obtained by connecting the outer surface of the one of the perimeter portions 15 and the second end 11b of the center portion 11 and connecting the outer surface of the other perimeter portion 15 and the first end 11a of the center portion 11. As the center pin 10 of the present embodiment is provided with the thus-configured end portions 17, the end portions 17 do not stick into the electrode group 9 even when the center pin 10 is deformed. Therefore, an internal short circuit due to the deformation of the center pin 10 is less likely to occur.

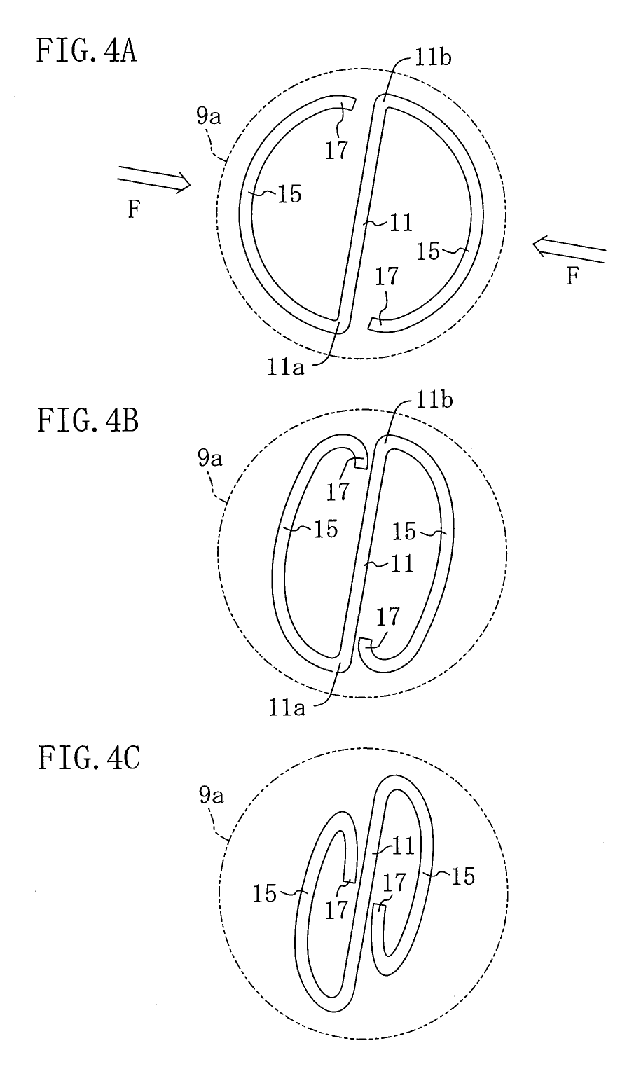

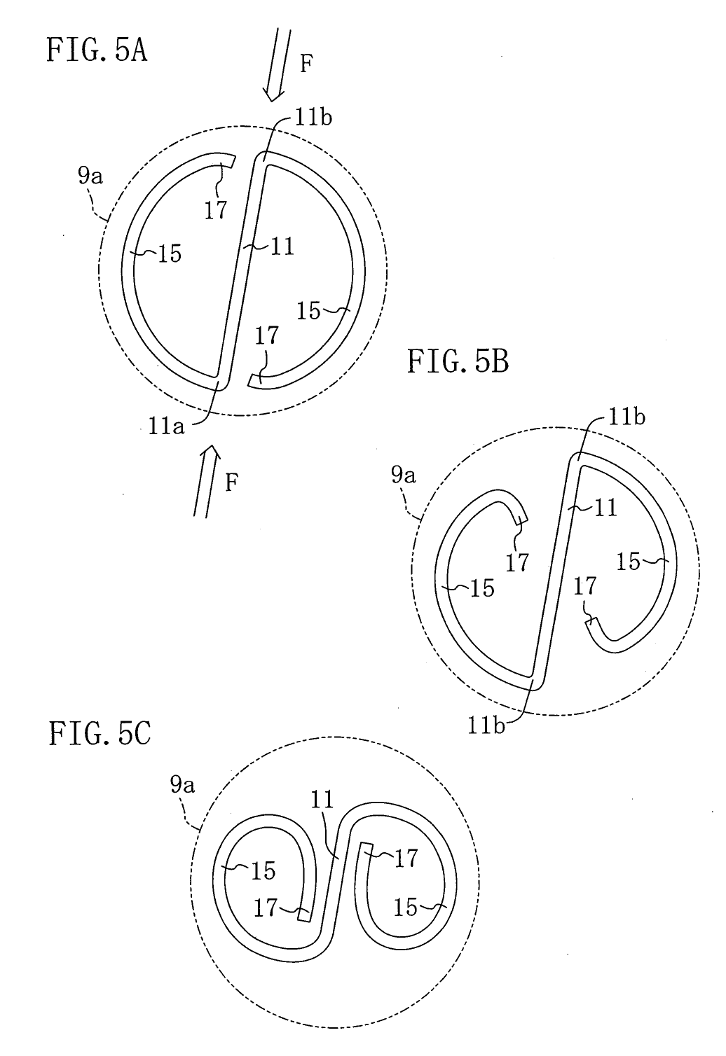

FIGS. 4A to 4C and FIGS. 5A to 5C schematically illustrate how the center pin 10 of the present embodiment is deformed when external force in the radial direction of the hollow cavity 9a is applied to the center pin 10.

For example, when external force in the horizontal direction is applied as shown in FIG. 4A, the center pin 10 is compressed in the horizontal direction. As a result, the end portions 17 are guided toward the inside of the hollow cavity 9a along the center portion 11 (FIG. 4B).

As the center pin 10 is kept compressed, the end portions 17 are further guided toward the inside of the hollow cavity 9a. Then, the center pin 10 is shaped into a spiral (FIG. 4C).

When external force in the vertical direction is applied as shown in FIG. 5A, the center pin 10 is compressed in the vertical direction. As a result, the end portions 17 are pressed by the external force toward the inside of the hollow cavity 9a (FIG. 5B).

As the center pin 10 is kept compressed, the end portions 17 are further moved toward the inside of the hollow cavity 9a (FIG. 5C).

In this way, according to the present embodiment, when the external force is applied, the center pin 10 is deformed into the spiral shape such that the edges of the end portions 17 come to the inside of the hollow cavity 9a. Accordingly, the end portions 17 are prevented from sticking into the electrode group 9. As the center pin 10 is deformed in this manner, an internal short circuit due to the deformation of the center pin 10 is less likely to occur even when the capacity of the lithium ion secondary battery is increased.

To be more specific, when the capacity of the lithium ion secondary battery is increased, the hollow cavity 9a of the electrode group 9 is reduced. Therefore, a distance between the outer surface of the center pin 10 and the inner wall surface of the electrode group 9 is reduced. As a result, the center pin 10, when deformed, is more likely to stick into the electrode group 9. According to the present embodiment, however, the end portions 17 are configured to be away from the inner wall surface of the hollow cavity 9a. Therefore, the center pin 10 is deformed into the spiral shape while the edges of the end portions 17 move inwardly. Thus, the present embodiment reduces the possibility that the center pin 10 sticks into the electrode group 9 when the capacity of the lithium ion secondary battery is increased, and therefore the internal short circuit due to the deformation of the center pin 10 is less likely to occur.

Further, as the end portions 17 are separated from the center portion 11, the slits 10a are formed between the first end 11a of the center portion 11 and the edge of one of the end portions 17 and between the second end 11b of the center portion 11 and the edge of the other end portion 17.

According to the present embodiment, as described above, the center pin 10 is provided with the slits 10a and the center portion 11. Therefore, even if gas is generated in the battery, the gas is efficiently emitted out of the battery.

According to the present embodiment, since the center pin 10 is provided with the thus-configured end portions 17, the end portions 17 do not come into contact with the inner wall surface of the hollow cavity 9a even if the center pin 10 is deformed. Therefore, the internal short circuit due to the deformation of the center pin 10 is less likely to occur. Further, even when the capacity of the lithium ion secondary battery is increased, the internal short circuit due to the deformation of the center pin 10 is less likely to occur.

Center pins 100, 110 and 120 according to Comparative Embodiments 1 to 3 as shown in FIGS. 11 to 13 may possibly reduce the gas emission efficiency or cause the internal short circuit due to the deformation of the center pin for the following reasons. Therefore, it is not preferable to insert either of the center pins 100, 110 and 120 into the hollow cavity 9a of the electrode group 9.

Unlike the center pin 10 of the present embodiment, the center pin 100 shown in FIG. 11 is not provided with the slits 10a. Therefore, according to Comparative Embodiment 1, gas generated in the lithium ion secondary battery is introduced into the inner space of the center pin 100 only through the open bottom of the center pin 100. For this reason, the structure of Comparative Embodiment 1 may be inferior in terms of gas emission efficiency.

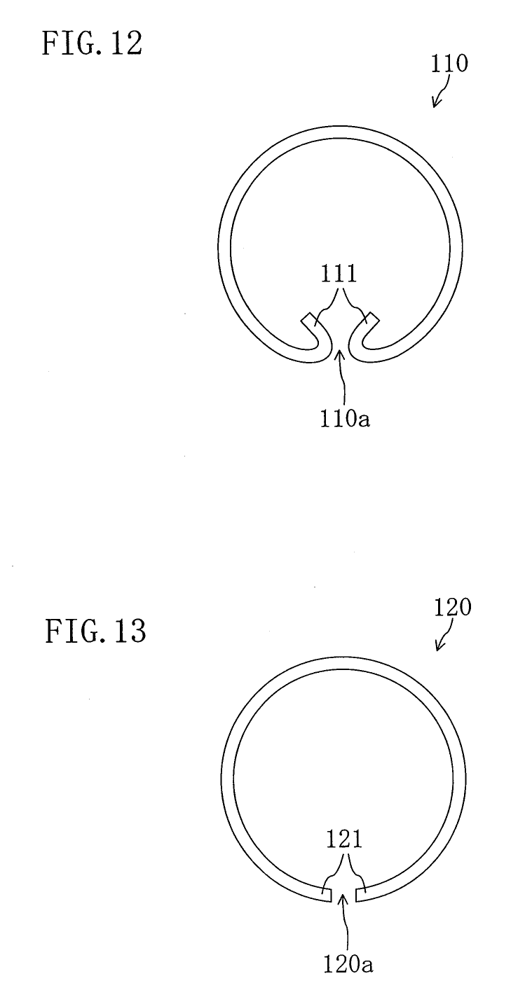

The center pins 110 and 120 shown in FIGS. 12 and 13 have the slits 10a, respectively, but they do not have the center portion 11. Therefore, when the center pin 110 or 120 is deformed, it may block the hollow cavity 9a of the electrode group 9. For this reasons, the structures of Comparative Embodiments 2 and 3 have difficulty in improving the gas emission efficiency.

When the center pin 120 of Comparative Embodiment 3 is deformed, the edge of the pin may possibly stick into the electrode group 9, thereby breaking the electrode group 9. Further, as shown in FIG. 13, if the center pin 120 has a sharp edge at the end thereof in the circumferential direction, the electrode group 9 is broken more easily as compared with the case where the sharp edge is not provided at the end of the center pin. Thus, with the structure of the center pin 120 according to Comparative Embodiment 3, it is difficult to reduce the possibility of the occurrence of the internal short circuit when the center pin 120 is deformed.

Back to the structure of the lithium ion secondary battery, an upper insulator 8a is provided on the top end of the electrode group 9 and a lower insulator 8b is provided below the bottom end of the electrode group 9.

An end of an aluminum positive electrode lead 5a is connected to the positive electrode 5 and the other end of the positive electrode lead 5a is connected to the sealing plate 2 serving also as a positive electrode terminal. An end of a nickel negative electrode lead 6a is connected to the negative electrode 6 and the other end of the negative electrode lead 6a is connected to the outer case 1 serving also as a negative electrode terminal.

The positive electrode 5 includes a material mixture layer formed on both or one of the surfaces of the current collector. The positive electrode material mixture layer contains an active material, a conductive agent, a binder and like elements. In the similar manner, the negative electrode 6 includes a material mixture layer formed on both or one of the surfaces of the current collector. The negative electrode material mixture layer contains an active material, a binder and like elements. The current collectors and the active materials used for the positive and negative electrodes 5 and 6 are not particularly limited and any known materials may be used. Examples of them are listed below.

First, in the positive electrode 5, examples of the active material may include lithium composite oxide (specifically, lithium cobaltate, lithium nickelate, lithium manganate or like oxide) and modified lithium composite oxide. Examples of the modified lithium composite oxide include lithium composite oxide described above mixed with an element such as aluminum or magnesium. Examples of the modified lithium composite oxide further includes lithium cobaltate mixed with nickel or manganese, lithium nickelate mixed with cobalt or manganese or lithium manganate mixed with cobalt or nickel.

The conductive agent is preferably made of a material which is not decomposed or fused but remains stable when the potential of the positive electrode 5 is applied. For example, graphite, carbon black, metal powder or like material may be used.

The binder is preferably made of a material which is not decomposed or fused but remains stable when the potential of the positive electrode 5 is applied. For example, polyvinylidene fluoride (PVDF), polytetrafluoroethylene (PTFE) or like material may be used.

The current collector is preferably made of a material which is not decomposed or fused but remains stable when the potential of the positive electrode 5 is applied. For example, aluminum foil may be used. Pores may be formed in the aluminum foil.

Then, in the negative electrode 6, examples of the active material may include natural graphite, artificial graphite, aluminum, various kinds of alloys based on aluminum, metal oxides such as tin oxide and metal nitrides.

The binder is preferably made of a material which is not decomposed or fused but remains stable when the potential of the negative electrode 6 is applied. For example, styrene-butadiene rubber (SBR), carboxymethyl cellulose (CMC) or like material may be used.

The current collector is preferably made of a material which is not decomposed or fused but remains stable when the potential of the negative electrode 6 is applied. For example, a copper foil may be used. Pores may be formed in the copper foil.

The porous insulating layer 7 may be a microporous film or nonwoven fabric made of polyolefin. A layer in which a plurality of insulating particles are bonded together with a binder may also be used. For improved heat resistance, the latter layer is preferably used. In either case, the porous insulating layer 7 has a porosity of 30 to 80%, preferably 40 to 80%, more preferably 50 to 80%. When the porosity of the porous insulating layer 7 is not lower than 30%, particularly not lower than 40%, it is preferable because degradation of charge-discharge characteristic when a large current is applied to the battery and degradation of charge-discharge characteristic in a low temperature environment are less likely to occur. However, if the porosity exceeds 80%, it is not preferable because the mechanical strength of the porous insulating layer 7 is reduced.

The insulating particles are preferably chemically stable. The term “chemically stable” means that the insulating particles are not affected by a nonaqueous electrolyte even in contact with it, that the particles are not decomposed or reacted when an oxidation-reduction potential is applied to the positive and negative electrodes 5 and 6 and that the particles do not cause any side reactions which may affect the battery characteristic. To be more specific, examples of the insulating particles include alumina, titania, zirconia, magnesia, zinc oxide and oxides such as silica. Among them, alumina, in particular α-alumina, is preferably used.

The positive electrode 5, the negative electrode 6 and the porous insulating layer 7 (particularly the porous insulating layer 7) supports an electrolyte thereon.

Examples of the electrolyte may include a nonaqueous electrolytic solution and a gelled electrolyte made of a nonaqueous electrolytic solution mixed with a polymeric material. The nonaqueous electrolytic solution is made of a nonaqueous solvent and a solute.

Examples of the solute include lithium salts such as lithium phosphate hexafluoride (LiPF₆) and lithium borate tetrafluoride (LiBF₄).

Preferable examples of the nonaqueous solvent include ethylene carbonate, cyclic carbonates (e.g., propylene carbonate), chain carbonates (e.g., dimethyl carbonate, diethyl carbonate or ethyl methyl carbonate) and like material, but they are not limitative. Among them, a single nonaqueous solvent may be used solely or two or more of them may be used in combination. An additive may be mixed in the nonaqueous solvent. For example, vinylene carbonate, cyclohexylbenzene or diphenyl ether may be used as the additive.

The lithium ion secondary battery of the present embodiment is preferably manufactured by the following method.

First, the positive electrode 5 and the negative electrode 6 are prepared. To be more specific, an active material of the positive electrode 5 is kneaded with a conductive agent of the positive electrode 5 and a binder of the positive electrode 5 to prepare paste of the positive electrode 5. The paste is then applied to both or one of the surfaces of the current collector of the positive electrode 5. In this step, the paste is applied not to cover one of the lengthwise ends of the current collector of the positive electrode 5. In this manner, the positive electrode 5 is prepared.

In a similar manner, an active material of the negative electrode 6 is kneaded with a binder of the negative electrode 6 to prepare paste of the negative electrode 6. The paste is then applied to both or one of the surfaces of the current collector of the negative electrode 6. In this step, the paste is applied not to cover one of the lengthwise ends of the current collector of the negative electrode 6. In this manner, the negative electrode 6 is prepared.

Then, a positive electrode plate and a negative electrode plate are prepared. To be more specific, a positive electrode lead 5a is welded to part of the current collector of the positive electrode 5 not covered with the paste of the positive electrode 5. A negative electrode lead 6a is also welded to part of the current collector of the negative electrode 6 not covered with the paste of the negative electrode 6.

Next, the positive electrode plate and the negative electrode plate are wound around a winding shaft with a porous insulating layer 7 interposed therebetween to prepare an electrode group 9. In this step, the positive electrode plate and the negative electrode plate are arranged such that the positive electrode lead 5a and the negative electrode lead 6a extends in the opposite directions.

The electrode group 9 is then placed in an outer case 1 having a closed end and the negative electrode lead 6a is welded to the bottom of the outer case 1. Thereafter, the winding shaft is removed from the electrode group 9 and the center pin 10 is inserted in the space that has been occupied by the winding shaft.

After the nonaqueous electrolyte is injected in the outer case 1, the positive electrode lead 5a is welded to the sealing plate 2 and an opening of the outer case 1 is sealed by crimping the sealing plate 2 thereon with a resin gasket 3 interposed therebetween. In this way, the lithium ion secondary battery is manufactured.

As described above, the lithium ion secondary battery of the present embodiment makes it possible to emit the gas, if generated in the battery, with efficiency. Further, even when the electrode group 9 is compressed in the radial direction, the gas emission passage is surely maintained. With use of the center pin 10 according to the present embodiment, break of the electrode group 9 due to the deformation of the center pin 10 is prevented even when the capacity of the lithium ion secondary battery is increased, and therefore the internal short circuit is less likely to occur. Thus, according to the present invention, the lithium ion secondary battery is provided with excellent safety and high reliability.

### Embodiment 2

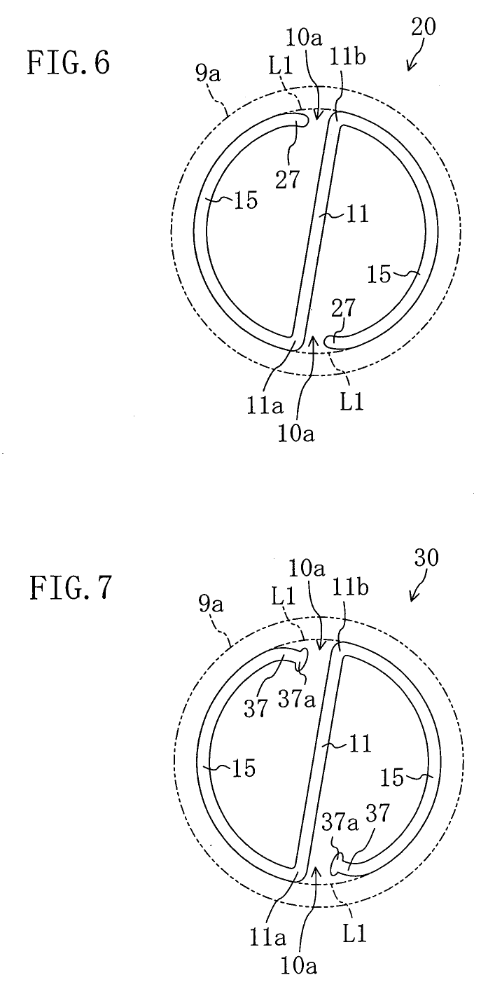

FIG. 6 is a cross sectional view of a center pin 20 according to Embodiment 2.

The center pin 20 of the present embodiment is different from the center pin 10 of Embodiment 1 in that the edges of end portions 27 are chamfered, in particular rounded. Since the edges of the end portions 27 are chamfered, when the edges of the end portions 27 come into contact with the electrode group 9 upon the deformation of the center pin 20, they are less likely to stick into the electrode group 9.

Though not particularly limited, the center pin 20 of the present embodiment may be formed by a method of chamfering the lengthwise edges of a thin plate after the plate is cut, and then winding the thin plate. Alternatively, the thin plate may be cut and wound first, and then the edges of the end portions 27 may be chamfered.

In the present embodiment, the edges of the end portions 27 are less likely to stick into the electrode group as long as they are chamfered to remove the sharpness. Therefore, the length of a radius of the rounded edges is not particularly limited. The length of the radius of the rounded edges is suitably selected depending on the thickness of the center pin 10 and other factors.

### Embodiment 3

FIG. 7 is a cross sectional view of a center pin 30 according to Embodiment 3.

The center pin 30 of the present embodiment is different from the center pin 10 of Embodiment 1 in that thick parts 37a are formed at the edges of end portions 37. Since the edges of the end portions 37 are thickened in this way, when the edges of the end portions 37 come into contact with the electrode group 9 upon the deformation of the center pin 30, they are less likely to stick into the electrode group 9 as described in Embodiment 2. Further, as shown in FIG. 7, if the edges of the thick parts 37a are chamfered to be rounded, it is preferable because the edges of the end portions 37 are much less likely to stick into the electrode group 9.

Though not particularly limited, the center pin 30 of the present embodiment may be formed by a method of thickening the lengthwise edges of a thin plate after the plate is cut, and then winding the thin plate. Alternatively, the thin plate may be cut and wound first, and then the edges of the end portions 37 may be thickened.

### Embodiment 4

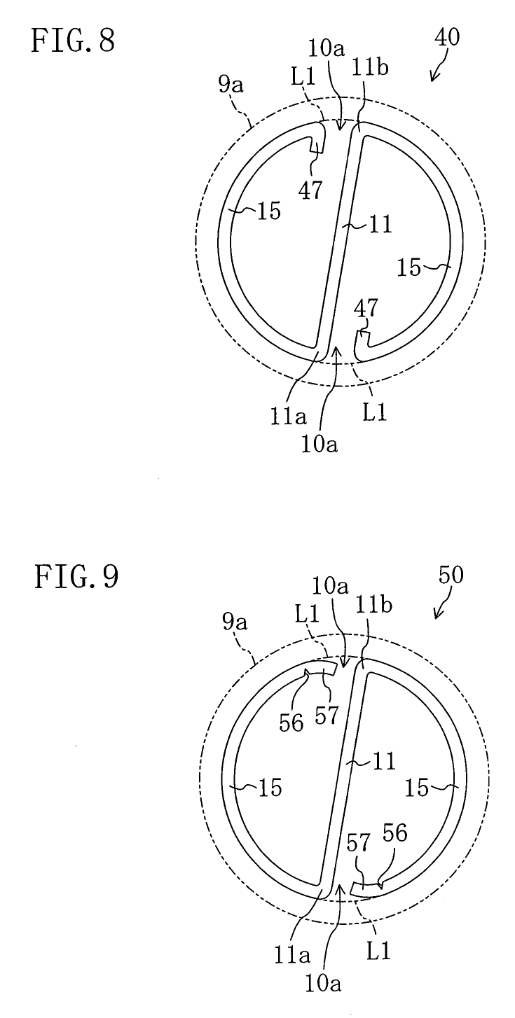

FIG. 8 is a cross sectional view of a center pin 40 according to Embodiment 4.

The center pin 40 of the present embodiment is different from the center pin 10 of Embodiment 1 in that end portions 47 are bent such that each of them is positioned between the center portion 11 and the corresponding perimeter portion 15. With this configuration, as described in Embodiment 1, the edges of the end portions 47 are less likely to come into contact with the electrode group 9 even when the center pin 40 is deformed.

Though not particularly limited, the center pin 40 of the present embodiment may be formed by bending the lengthwise ends of a thin plate after the plate is cut, and then winding the plate. Alternatively, the thin plate may be cut and wound first, and then the edges of the end portions 47 may be bent toward the inside of the hollow cavity 9a.

### Embodiment 5

FIG. 9 is a cross sectional view of a center pin 50 according to Embodiment 5.

The center pin 50 of the present embodiment is different from the center pin 10 of Embodiment 1 in that notches 56 are formed in parts of the center pin 40 between the perimeter portions 15 and the end portions 57, respectively. Each notch 56 is formed from the inside to the outside of the hollow cavity 9a. When compressed in the radial direction, the thus-configured center pin 50 is bent at the notches 56 and deformed into the shape shown in FIG. 8. Therefore, as described in Embodiment 4, the edges of the end portions 57 are less likely to come into contact with the electrode group 9 even when the center pin 50 is deformed.

Though not particularly limited, the center pin 50 of the present embodiment may be formed by providing the notches 56 in a thin plate after the plate is cut, and then winding the thin plate. Alternatively, the thin plate may be cut and wound first, and then the notches 56 may be formed.

### Embodiment 6

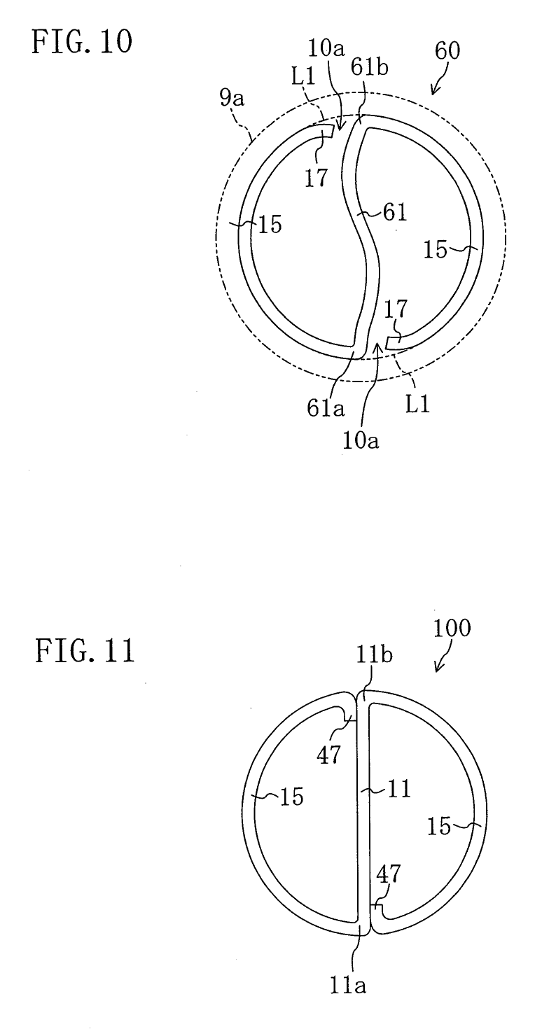

FIG. 10 is a cross sectional view of a center pin 60 according to Embodiment 6.

The center pin 60 of the present embodiment is different from the center pin 10 of Embodiment 1 in that a center portion 61 is slightly warped. Even when the thus-configured center pin 60 is used, the same effect as that explained in Embodiment 1 is obtained.

### Other Embodiments

The center pins of Embodiments 1 to 6 described above may be configured as follows.

The center pin is sufficiently effective as long as it includes the end portions described in Embodiment 1. It is more preferable that the center pin includes the center portion. Therefore, the shape of the center pin is not limited to those shown in FIG. 3 and FIGS. 6 to 10.

The shape of the lithium ion secondary battery is not particularly limited. For example, the battery may be in the cylindrical shape or the flat shape.

In the electrode group, current collection may be performed in the lengthwise direction of the current collector as described above, or it may be performed in the width direction of the current collector.

In the preparation of the negative electrode, the negative electrode paste was applied to both or one of the surfaces of the negative electrode current collector. However, when an alloy is used as a negative electrode active material, vapor deposition may be used to deposit the negative electrode active material on both or one of the surfaces of the negative electrode current collector.

### EXAMPLES

### Example 1

### (Preparation of Positive Electrode)

First, 1.7 parts by weight of polyvinylidene fluoride (PVDF) (a binder) was dissolved into a N-methyl-pyrrolidone (NMP) solvent and 1.25 parts by weight of acetylene black was mixed into the resulting solution to prepare a conductive agent.

Then, the conductive agent was mixed into 100 parts by weight of LiNiCoAlO₂ (a positive electrode active material) to obtain paste. The paste was applied to both surfaces of a 15 μm thick aluminum foil (a positive electrode current collector) and dried. The resulting product was rolled and cut. In this way, a positive electrode of 0.125 mm in thickness, 57 mm in width and 667 mm in length was obtained.

### (Preparation of Negative Electrode)

First, 100 parts by weight of flaky artificial graphite was ground and classified to obtain artificial graphite having an average particle diameter of about 20 μm.

Next, an aqueous solution containing 1 wt % of carboxymethyl cellulose was prepared. Then, 100 parts by weight of this aqueous solution and 3 parts by weight of styrene-butadiene rubber (a binder) were added to the flaky artificial graphite to obtain paste. The paste was applied to both surfaces of a 8 μm thick copper foil (a negative electrode current collector) and dried. The resulting product was rolled and cut. In this way, a negative electrode of 0.156 mm in thickness, 58.5 mm in width and 750 mm in length was obtained.

### (Preparation of Nonaqueous Electrolytic Solution)

To a solution mixture containing ethylene carbonate and dimethyl carbonate in the volume ratio of 1:3, 5 wt % of vinylene carbonate was added. To the resulting solution mixture, LiPF₆ was dissolved at a concentration of 1.4 mol/m³. Thus, a nonaqueous electrolytic solution was obtained.

### (Preparation of Center Pin)

In Example 1, the center pin shown in FIG. 8 was used. Specifically, a 0.3 mm thick stainless steel plate was bent into a cylindrical pin having a S-shaped cross section. The obtained center pin had an outer diameter of 3.5 mm and a length of 55 mm.

### (Preparation of Cylindrical Battery)

First, an aluminum lead (a positive electrode lead) was attached to the positive electrode current collector and a nickel lead (a negative electrode lead) was attached to the negative electrode current collector. Then, the positive electrode current collector and the negative electrode current collector were wound with a polyethylene separator interposed therebetween to prepare an electrode group. In this step, the positive electrode, the separator and the negative electrode were wound around a winding shaft and the shaft was removed after the winding was finished. As a result, a hollow cavity was left in space that had been occupied by the winding shaft.

After an insulator was arranged below the electrode group, the negative electrode lead was welded to the outer case, the positive electrode lead was welded to the sealing plate, and the electrode group was placed in the outer case. The sealing plate was provided with an internal pressure activated safety valve.

The center pin was then inserted in the hollow cavity of the electrode group and an insulator was placed on the electrode group.

Then, a nonaqueous electrolytic solution was poured into the outer case under reduced pressure.

Finally, the sealing plate was crimped onto the opening end of the outer case with a gasket interposed therebetween. In this way, the lithium ion secondary battery of Example 1 was prepared. The obtained battery had a diameter of 17.5 mm, a height of 65 mm and a capacity of 2.8 Ah.

### Example 2

A lithium ion secondary battery of Example 2 was prepared in the same manner as that of Example 1 except that the center pin shown in FIG. 3 was used. Specifically, a 0.3 mm thick stainless steel plate was bent into a cylindrical pin having a S-shaped cross section. Further, the edges of the center pin in the circumferential direction were chamfered into a round shape. The obtained center pin had an outer diameter of 3.5 mm and a length of 55 mm.

### Example 3

A lithium ion secondary battery of Example 3 was prepared in the same manner as that of Example 1 except that the center pin shown in FIG. 10 was used. Specifically, a 0.3 mm thick stainless steel plate was bent into a cylindrical pin having a S-shaped cross section. Further, the center portion of the center pin was warped. The obtained center pin had an outer diameter of 3.5 mm and a length of 55 mm.

### Example 4

A lithium ion secondary battery of Example 4 was prepared in the same manner as that of Example 1 except that the center pin shown in FIG. 9 was used. Specifically, a 0.3 mm thick stainless steel plate was bent into a cylindrical pin having a S-shaped cross section. Further, a notch having a depth of 0.15 mm and a width of 0.3 mm was formed in part of the center pin 1 mm inside from each of the edges of the end portions. The obtained center pin had an outer diameter of 3.5 mm and a length of 55 mm.

### Example 5

A lithium ion secondary battery of Example 5 was prepared in the same manner as that of Example 1 except that the center pin shown in FIG. 6 was used. Specifically, a 0.3 mm thick stainless steel plate was bent into a cylindrical pin having a S-shaped cross section. Further, each of the edges of the end portions was rounded to have a diameter of 0.3 mm. The obtained center pin had an outer diameter of 3.5 mm and a length of 55 mm.

### Example 6

A lithium ion secondary battery of Example 6 was prepared in the same manner as that of Example 1 except that the center pin shown in FIG. 9 was used. Specifically, a 0.3 mm thick stainless steel plate was bent into a cylindrical pin having a S-shaped cross section. Further, each of the edges of the end portions was rounded to have a diameter of 0.6 mm. The obtained center pin had an outer diameter of 3.5 mm and a length of 55 mm.

### Comparative Example 1

A lithium ion secondary battery of Comparative Example 1 was prepared in the same manner as that of Example 1 except that the center pin shown in FIG. 11 was used. Specifically, a 0.3 mm thick stainless steel plate was bent into a cylindrical pin having a S-shaped cross section. The obtained center pin had an outer diameter of 3.5 mm and a length of 55 mm.

### Comparative Example 2

A lithium ion secondary battery of Comparative Example 2 was prepared in the same manner as that of Example 1 except that the center pin shown in FIG. 12 was used. Specifically, a 0.3 mm thick stainless steel plate was shaped into a cylindrical pin and the edges thereof in the circumferential direction were bent toward the inside with a gap of 0.3 mm kept between the edges. The obtained center pin had an outer diameter of 3.5 mm and a length of 55 mm.

### Comparative Example 3

A lithium ion secondary battery of Comparative Example 3 was prepared in the same manner as that of Example 1 except that the center pin shown in FIG. 13 was used. Specifically, a 0.3 mm thick stainless steel plate was shaped into a cylindrical pin with the edges thereof in the circumferential direction spaced from each other to have a gap of 0.3 mm. The obtained center pin had an outer diameter of 3.5 mm and a length of 55 mm.

### (Crush Test)

Batteries of Examples 1 to 6 and batteries of Comparative Examples 1 to 3, 20 pieces each, were prepared. These batteries were charged at a constant current of 2.8 A to 4.2 V, and then charged at a constant voltage of 4.2 V to a current value of 50 mA. Then, these batteries were subjected to a crush test using a rod in conformity with the UL Standard 1642. To be more specific, a battery was laid on a table or the like and a metal rod having a diameter of 7.9 mm was placed on the battery. The rod was positioned in the middle of the battery height to extend in the direction orthogonal to the battery height. Then, a 9.1 kg weight was dropped thereon from a height of 61 cm from the barrel of the battery.

After the crush test, the batteries were inspected whether a short circuit had occurred or not. The results are shown in Table 1.

As shown in Table 1, none of the tested batteries of Examples 1 to 6 and Comparative Examples 1 and 2 caused a short circuit. After the crush test, each of the batteries was disassembled to check the degree of break of the electrode group due to the deformation of the center pin. However, the break of the electrode group was not observed at all.

In contrast, the short circuit occurred in three of the tested batteries of Comparative Example 3. Each of the three batteries was disassembled, in which the center pin was deformed and stuck into the electrode group.

In summary, in the batteries of Examples 1 to 6 and Comparative Examples 1 and 2, the center pin was deformed but the edge of the center pin did not stick into the electrode group. Therefore, the short circuit did not occur. On the other hand, in the batteries of Comparative Example 3, the deformed center pin stuck into the electrode group, thereby causing the short circuit.

### (Hot Plate Test)

Batteries of Examples 1 to 6 and batteries of Comparative Examples 1 to 3, 10 pieces each, were prepared. These batteries were heated and the number of exploded batteries was count. More specifically, fully charged batteries were placed and left stand on a hot plate heated to 250° C. Then, the number of batteries whose outer case diameter was increased by 1 mm or more was count. Table 1 shows the results.

As shown in Table 1, none of the batteries of Examples 1 to 6 expanded to such a degree that the outer case diameter was increased by 1 mm or more. On the other hand, half the batteries of Comparative Example 1 and two of the batteries of Comparative Examples 2 and 3, respectively, showed the increase of the outer case diameter by 1 mm or more.

The following inferences are made from the aforementioned test results. In the batteries of Examples 1 to 6 including two slits provided in the center pin, gas generated by heating was smoothly guided to the inner space of the center pin and emitted out of the battery. As a result, the outer case diameter was hardly increased.

On the other hand, in the batteries of Comparative Example 1 in which the slits were not provided in the center pin, the gas generated by heating was not guided to the inner space of the center pin and not emitted out of the battery. As a result, the outer case diameter was increased by 1 mm or more.

In the batteries of Comparative Examples 2 and 3 in which only a single slit was provided in the center pin, it was difficult to guide the gas generated by heating to the inner space of the center pin. As a result, the outer case diameter was increased by 1 mm or more.

TABLE 1

| | | Number of batteries with the |
|---|---|---|
| | Number of internal | outer case diameter |
| | short-circuited batteries | increased by 1 mm or more |
| Example 1 | 0/20 | 0/10 |
| Example 2 | 0/20 | 0/10 |
| Example 3 | 0/20 | 0/10 |
| Example 4 | 0/20 | 0/10 |
| Example 5 | 0/20 | 0/10 |
| Example 6 | 0/20 | 0/10 |
| Example 7 | 0/20 | 0/10 |
| Comparative | 0/20 | 5/10 |
| Example 1 | | |
| Comparative | 0/20 | 2/10 |
| Example 2 | | |
| Comparative | 3/20 | 2/10 |
| Example 3 | | |

What is claimed is:

1. A nonaqueous electrolyte secondary battery comprising:
an electrode group formed by winding a positive electrode and a negative electrode with a porous insulating layer interposed therebetween and a hollow cavity extending in the axial direction of the electrode group; and
a cylindrical center pin arranged in the hollow cavity to extend in the axial direction of the electrode group, wherein
the center pin includes:
a center portion extending in the radial direction of the hollow cavity;
a perimeter portion extending along an inner wall surface of the hollow cavity from an end of the center portion in the radial direction of the hollow cavity; and
an end portion extending from an end of the perimeter portion in the circumferential direction toward the inside of the hollow cavity to be away from the inner wall surface of the hollow cavity but separated from the center portion.

2. The nonaqueous electrolyte secondary battery of claim 1, wherein an edge of the end portion is chamfered.

3. The nonaqueous electrolyte secondary battery of claim 1, wherein the edge of the end portion is thicker than the perimeter portion.

4. The nonaqueous electrolyte secondary battery of claim 1, wherein the center pin is curved such that the end portion is positioned between the center portion and the perimeter portion.

5. The nonaqueous electrolyte secondary battery of claim 1, wherein a notch is formed at a boundary between the perimeter portion and the end portion of the center pin, the notch being formed from the inside to the outside of the hollow cavity.

6. The nonaqueous electrolyte secondary battery of claim 1, wherein the center pin includes a slit extending in the axial direction thereof between the end portion and the center portion.
